(19) United States
(12) Patent Application Publication
(10) Pub. No.: US 2013/0157852 A1
(43) Pub. Date: Jun. 20, 2013

(54) HERBICIDAL COMPOSITION CONTAINING FLUROXYPYR AND GLYPHOSATE

(71) Applicant: DOW AGROSCIENCES LLC, Indianapolis, IN (US)

(72) Inventor: Richard K. Mann, Franklin, IN (US)

(73) Assignee: DOW AGROSCIENCES LLC, Indianapolis, IN (US)

(21) Appl. No.: 13/720,165

(22) Filed: Dec. 19, 2012

Related U.S. Application Data
(60) Provisional application No. 61/577,695, filed on Dec. 20, 2011.

(51) Int. Cl. A01N 57/20; A01N 43/40

(52) U.S. Cl. CPC A01N 57/20; A01N 43/40
USPC 504/103; 504/128

(57) ABSTRACT

Herbicidal compositions containing fluoroxypyr and glyphosate.

### CROSS REFERENCE TO RELATED APPLICATIONS

This application claims the benefit of U.S. Provisional Patent Application Ser. No. 61/577,695, filed Dec. 20, 2011, the entirety of which is incorporated herein by reference in its entirety

### FIELD

This disclosure concerns a synergistic herbicidal composition containing (a) fluoroxypyr and (b) glyphosate for controlling the growth of undesirable vegetation, e.g., in orchards, range and pasture, industrial vegetation management (IVM), rights-of-way and in any glyphosate-tolerant crop, such as glyphosate-tolerant corn, glyphosate-tolerant cereal crops (including but not exclusive to wheat, barley, rice, sorghum, triticale, oats and rye), glyphosate-tolerant broadleaf crops, and any fluoroxypyr-tolerant crop. These compositions are disclosed as providing, among other things, improved post-emergence herbicidal weed control.

### BACKGROUND

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use.

In some cases, herbicidal active ingredients have been shown to be more effective in combination than when applied individually and this is referred to as “synergism.” As described in the Herbicide Handbook of the Weed Science Society of America, Ninth Edition, 2007, p. 429 “‘synergism’ [is] an interaction of two or more factors such that the effect when combined is greater than the predicted effect based, in part, on the response to each factor applied separately.” The present disclosure is based on the discovery that fluoroxypyr and glyphosate, already known individually for their herbicidal efficacy, display a synergistic effect when applied in combination.

### SUMMARY

The present disclosure concerns a synergistic herbicidal mixture comprising and methods of controlling vegetation utilizing an herbicidally effective amount of (a) fluoroxypyr and (b) glyphosate. The compositions may also contain an agriculturally acceptable adjuvant and/or carrier.

The present disclosure also concerns herbicidal compositions for and methods of controlling the growth of undesirable vegetation, e.g., in orchards, range and pasture, industrial vegetation management (IVM), rights-of-way and in any glyphosate-tolerant crop, such as glyphosate-tolerant corn, glyphosate-tolerant cereals (including but not exclusive to wheat, barley, rice, oats and rye), glyphosate-tolerant broadleaf crops, fluoroxypyr-tolerant crops.

### DETAILED DESCRIPTION

Provided herein are compositions comprising a herbicidally effective amount of (a) fluoroxypyr or an ester or salt thereof and (b) glyphosate or an ester or salt thereof.

Provided herein are also methods for controlling undesirable vegetation comprising contacting the vegetation, locus of the vegetation, soil, or water a herbicidally effective amount of (a) fluoroxypyr or an ester or salt thereof and (b) glyphosate or an ester or salt thereof.

Fluoroxypyr is the common name for 2-[(4-amino-3,5-dichloro-6-fluoro-2-pyridinyl)oxy]acetic acid. Its herbicidal activity is described in The Pesticide Manual, Fifteenth Edition, 2009. Fluoroxypyr controls a range of economically important broadleaf weeds in small grain crops. Exemplary forms of fluoroxypyr include, e.g., fluoroxypyr-meptyl. The structure of fluoroxypyr is:

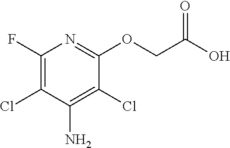 [SMILES: Nc1c(Cl)c(F)nc(OCC(=O)O)c1Cl]

Glyphosate, N-(phosphonomethyl)glycine is an EPSP synthase inhibitor. Its herbicidal activity is described in The Pesticide Manual, Fifteenth Edition, 2009. Glyphosate provides non-selective post-emergence weed control. Exemplary forms of glyphosate include e.g., glyphosate-isopropylammonium. The structure of glyphosate is:

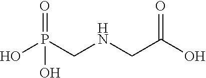

The term herbicide is used herein to mean an active ingredient that kills, controls or otherwise adversely modifies the growth of plants. A herbicidally effective or vegetation-controlling amount is an amount of active ingredient which causes an adversely modifying effect, including deviations from natural development, killing, regulation, desiccation, retardation, and the like. Methods of application include, but are not limited to applications to the vegetation or locus thereof, i.e., application to the area adjacent to the vegetation, as well as preemergence, postemergence, foliar, burndown and in-water applications.

The terms plants and vegetation include germinant seeds, emerging seedlings, plants emerging from vegetative propagules, and established vegetation.

Herbicidal activity is exhibited by the compounds when they are applied directly to the plant or to the locus of the plant at any stage of growth. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted as is known in the art to promote non-selective or selective herbicidal action. In some embodiments, the compositions provided herein are applied postemergence to relatively immature undesirable vegetation to achieve the maximum control of weeds.

The compositions and methods described herein be used to control undesirable vegetation in glyphosate-tolerant-, glufosinate-tolerant-, dicamba-tolerant-, phenoxy auxin-tolerant-, pyridyloxy auxin-tolerant-, aryloxyphenoxypropionate-tolerant-, acetyl CoA carboxylase (ACCase) inhibitor-tolerant-, imidazolinone-tolerant-, acetolactate synthase (ALS) inhibitor-tolerant-, 4-hydroxyphenyl-pyruvate dioxygenase (HPPD) inhibitor-tolerant-, protoporphyrinogen oxidase (PPO) inhibitor-tolerant-, triazine-tolerant-, bromoxynil-tolerant-crops (such as, but not limited to, soybean, cotton, canola/oilseed rape, rice, cereals, corn, turf, etc), for example, in conjunction with glyphosate, glufosinate, dicamba, phenoxy auxins, pyridyloxy auxins, aryloxyphenoxypropionates, ACCase inhibitors, imidazolinones, ALS inhibitors, HPPD inhibitors, PPO inhibitors, triazines, and bromoxynil. The compositions and methods may be used in controlling undesirable vegetation in crops possessing multiple or stacked traits conferring tolerance to multiple chemistries and/or inhibitors of multiple modes of action. In some embodiments, compositions and methods further employ additionalherbicides that are selective for the crop being treated and which complement the spectrum of weeds controlled by these compounds at the application rate employed. In some embodiments, the fluoroxypyr and glyphosate and other complementary herbicides are applied at the same time, either as a combination formulation or as a tank mix.

The compositions and methods provided herein are utilized to control undesirable vegetation. Undesirable vegetation includes, but is not limited to, undesirable vegetation that occurs in cereals, rice, range and pasture, row crops (e.g., corn, soybean, cotton, canola), turf, trees, vines, and ornamental species, aquatic or non-crop settings, (e.g., rights-of-way, industrial vegetation management).

In some embodiments, the compositions and methods provided herein are utilized to control undesirable vegetation in cereals. In certain embodiments, the undesirable vegetation is Alopecurus myosuroides Huds. (blackgrass, ALOMY), Apera spica-venti (L.) Beauv. (windgrass, APESV), Avena fatua L. (wild oat, AVEFA), Bromus tectorum L. (downy brome, BROTE), Lolium multiflorum Lam. (Italian ryegrass, LOLMU), Phalaris minor Retz. (littleseed canarygrass, PHAMI), Poa annua L. (annual bluegrass, POANN), Setaria pumila (Poir.) Roemer & J. A. Schultes (yellow foxtail, SETLU), Setaria viridis (L.) Beauv. (green foxtail, SETVI), Cirsium arvense (L.) Scop. (Canada thistle, CIRAR), Galium aparine L. (catchweed bedstraw, GALAP), Kochia scoparia (L.) Schrad. (kochia, KCHSC), Lamium purpureum L. (purple deadnettle, LAMPU), Matricaria recutita L. (wild chamomile, MATCH), Matricaria matricarioides (Less.) Porter (pineappleweed, MATMT), Papaver rhoeas L. (common poppy, PAPRH), Polygonum convolvulus L. (wild buckwheat, POLCO), Salsola tragus L. (Russian thistle, SASKR), Stellaria media (L.) Vill. (common chickweed, STEME), Veronica persica Poir. (Persian speedwell, VERPE), Viola arvensis Murr. (field violet, VIOAR), or Viola tricolor L. (wild violet, VIOTR).

In some embodiments, the compositions and methods provided herein are utilized to control undesirable vegetation in range and pasture. In certain embodiments, the undesirable vegetation is Ambrosia artemisiifolia L. (common ragweed, AMBEL), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Sida spinosa L. (prickly sida, SIDSP), Sinapis arvensis L. (wild mustard, SINAR), Sonchus arvensis L. (perennial sowthistle, SONAR), Solidago species (goldenrod, SOOSS), Taraxacum officinale G. H. Weber ex Wiggers (dandelion, TAROF), Trifolium repens L. (white clover, TRFRE), or Urtica dioica L. (common nettle, URTDI).

In some embodiments, the compositions and methods provided herein are utilized to control undesirable vegetation found in row crops. In certain embodiments, the undesirable vegetation is Alopecurus myosuroides Huds. (blackgrass, ALOMY), Avena fatua L. (wild oat, AVEFA), Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Lolium multiflorum Lam. (Italian ryegrass, LOLMU), Panicum dichotomiflorum Michx. (fall panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Asclepias syriaca L. (common milkweed, ASCSY), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Erigeron bonariensis L. (hairy fleabane, ERIBO), Erigeron canadensis L. (Canadian fleabane, ERICA), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Sida spinosa L. (prickly sida, SIDSP), Sinapis arvensis L. (wild mustard, SINAR), Solanum ptychanthum Dunal (eastern black nightshade, SOLPT), or Xanthium strumarium L. (common cocklebur, XANST).

In some embodiments, the compositions and methods provided herein are utilized to control undesirable vegetation in rice. In certain embodiments, the undesirable vegetation is Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEI-FA), Leptochloa panicoides (Presl.) Hitchc. (Amazon sprangletop, LEFPA), Panicum dichotomiflorum (L.) Michx. (fall panicum, PANDI), Paspalum dilatatum Poir. (dallisgrass, PASDI), Cyperus difformis L. (smallflower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SPCJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindernia dubia (L.) Pennell (low false pimpernel, LIDDU), Monochoria korsakowii Regel & Maack (monochoria, MOOKA), Monochoria vaginalis (Bunn. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (POLHP, mild smartweed), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

In some embodiments, the compositions and methods are utilized to control vegetation selected from the following genera: anagallis, axonopus, cirsium, calopogonium, commelina, convolvus, conyza, kochio, malva, mikania, ottochloa nodosa, pspalum polygonum, or urtica. In some embodiments, a the compositions and methods are utilized to control scarlet pimpernel (Anagallis arvensis L., ANGAR), tropical carpetgrass (Axonopus compressus, AXOCO), Canada thistle (Cirsium arvense (L.) Scop., CIRAR), calopo (Calopogonium mucunoides, CLOMU), Bengal dayflower (Commelina benghalensis L., COMBE), field bindweed (Convolvus arvensis L., CONAR), horseweed (Conyza canadensis (L.) Cronq., ERICA), kochia (Kochia scoparia (L.) Schrad., KCHSC), common mallow (Malva neglecta Wallr., MALNE), African mile-a-minute (Mikania cordata (Bunn. f.) B. L., MIKCO), slender panicgrass (Ottochloa nodosa, OTTNO), paspalum (Paspalum conjugatum Bergius, PASCO), wild buckwheat (Polygonum convolvulus L., POLCO) and stinging nettle (Urtica dioica L., URTDT) at application rates equal to or lower than the rates of the individual compounds.

The compounds or agriculturally acceptable salt or ester thereof may be used to control herbicide resistant or tolerant weeds. The methods employing the combination of fluoroxypyr and glyphosate, or agriculturally acceptable salt or ester thereof, and the compositions described herein may also be employed to control herbicide resistant or tolerant weeds. Exemplary resistant or tolerant weeds include, but are not limited to, biotypes resistant or tolerant to acetolactate synthase (ALS) inhibitors, photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, multiple chemical classes, and multiple herbicide modes-of-action.

In certain embodiments of the compositions and methods described herein, the weight ratio of glyphosate to fluoroxypyr at which the herbicidal effect is synergistic lies within the range from about 1:2 to about 70:1, preferably from about 1:1 to about 40:1. The rate at which the synergistic composition is applied will depend upon the particular type of weed to be controlled, the degree of control required, and the timing and method of application. In certain embodiments, the compositions described herein can be applied at an application rate from about 330 grams of acid equivalent per hectare (gae/ha) to about 3920 gae/ha based on the total amount of active ingredients in the composition. In certain embodiments, fluoroxypyr is applied at a rate from about 50 gae/ha to about 560 gae/ha and glyphosate is applied at a rate from about 280 gae/ha to about 3360 gae/ha. In certain embodiments, fluoroxypyr is applied at a rate from about 50 gae/ha to about 400 gae/ha and glyphosate is applied at a rate from about 360 gae/ha to about 2000 gae/ha. In certain embodiments, fluoroxypyr is applied at a rate from about 50 gae/ha to about 200 gae/ha and glyphosate is applied at a rate from about 360 gae/ha to about 1100 gae/ha. In certain embodiments, fluoroxypyr is applied at a rate from about 200 gae/ha to about 400 gae/ha and glyphosate is applied at a rate from about 710 gae/ha to about 1500 gae/ha. In certain embodiments, fluoroxypyr is applied at a rate from about 300 gae/ha to about 400 gae/ha and glyphosate is applied at a rate from about 1000 gae/ha to about 2000 gae/ha.

In some embodiments of the methods described herein, the fluoroxypyr or salt or ester thereof and glyphosate or salt or ester thereof are applied simultaneously, including, e.g., in the form of a composition. In some embodiments, the components are applied sequentially, e.g., within 5, 10, 15, or 30 minutes of each other; 1, 2, 3, 4, 5, 10, 12, 24, 48 hour(s) or each other, or 1 week of each other.

In some embodiments of the compositions and methods described herein, the carboxylic acid equivalent weight ratio of fluoroxypyr or salt or ester thereof to glyphosate or salt or ester thereof is from 2:1 to 1:40. As used herein, carboxylic acid equivalent (or acid equivalent weight ratio) of fluoroxypyr or salt or ester thereof to glyphosate or salt or ester thereof refers to the ratio of the weight of fluoroxypyr, or if a salt or ester of fluoroxypyr, the weight, based on molar equivalents, of the corresponding carboxylic acid of the salt or ester, to the weight of glyphosate, or if a salt or ester of glyphosate, the weight of the corresponding carboxylic acid or the salt of the ester. For example, if the number of moles for a given amount of fluoroxypyr meptyl is X grams, the acid equivalent weight would be the weight of X moles of fluoroxypyr (which is a carboxylic acid). In certain embodiments, the weight ratio is from 1:1 to 1:20. In certain embodiments, the weight ratio is from 1:2.5 to 1:10.

In some embodiments, the compositions comprise and the methods utilize fluoroxypyr meptyl and glyphosate ammonium, wherein the acid equivalent weight ratio of fluoroxypyr meptyl to glyphosate ammonium is from 2:1 to 1:40. In certain embodiments, the weight ratio is from 1:1 to 1:20. In certain embodiments, the weight ratio is from 1:2.5 to 1:10.

The components of the synergistic mixtures described herein can be applied either separately or as part of a multipart herbicidal system.

The synergistic mixtures and methods described herein, in some embodiments, can be utilized in conjunction with one or more other herbicides to control a wider variety of undesirable vegetation. When used in conjunction with other herbicides, the composition can be formulated with the other herbicide or herbicides, tank-mixed with the other herbicide or herbicides or applied sequentially with the other herbicide or herbicides. Some of the herbicides that can be employed in conjunction with the synergistic compositions described herein include: 4-CPA; 4-CPB; 4-CPP; 2,4-D; 3,4-DA; 2,4-DB; 3,4-DB; 2,4-DEB; 2,4-DEP; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazon, bentazone, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, flurtamone, fluthiacet, fomesafen, foramsulfuron, fosamine, furyloxyfen, glufosinate, glufosinate-P, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone-methyl, thifensulfuron, thiobencarb, tiocarbazil, tioclorim, topramezone, tralkoxydim, triafamone, tri-allate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac tritosulfuron, vernolate, DE-729 (halauxifen), xylachlor and salts, esters, optically active isomers and mixtures thereof.

The synergistic compositions and methods described herein can, further, be used in conjunction with glufosinate, dicamba, imidazolinones, sulfonylureas, or 2,4-D on glyphosate-tolerant, glufosinate-tolerant, dicamba-tolerant, imidazolinone-tolerant, sulfonylurea-tolerant and 2,4-D-tolerant crops, as well as crops that are resistant to glyphosate+fluoroxypyr. In some embodiments, the synergistic compositions and methods described herein in combination with herbicides that are selective for the crop being treated and which complement the spectrum of weeds controlled by these compounds at the application rate employed. In some embodiments, the synergistic compositions described herein or active ingredients of the compositions and other complementary herbicides at the same time, either as a combination formulation or as a tank mix. The synergistic compositions and methods described herein can generally be employed in combination with known herbicide safeners, such as benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, harpin proteins, isoxadifen-ethyl, mefenpyr-diethyl, MG 191, MON 4660, naphthalic anhydride (NA), oxabetrinil, R29148 and N-phenyl-sulfonylbenzoic acid amides, to enhance their selectivity.

In some embodiments, the compositions described herein comprise at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, or wettable powders, or liquids, such as, for example, emulsifiable concentrates, solutions, emulsions or suspensions. They can also be provided as a pre-mix or tank mixed.

Suitable agricultural adjuvants and carriers are well known to those skilled in the art. Some of these adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8E0); tallow amine ethoxylate (15 EO); PEG(400) dioleate-99.

Liquid carriers that can be employed include water and organic solvents. The organic solvents typically used include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

In some embodiments, one or more surface-active agents are incorporated into the compositions described herein. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical Publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutyl-naphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono- and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, particularly methyl esters.

Oftentimes, some of these materials, such as vegetable or seed oils and their esters, can be used interchangeably as an agricultural adjuvant, as a liquid carrier or as a surface active agent.

Other additives commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium sulfate, ammonium nitrate, urea and the like.

The concentration of the active ingredients in the synergistic compositions described herein is generally from 0.1 to 98 percent by weight. Concentrations from 10 to 90 percent by weight are often employed. In compositions designed to be employed as concentrates, the active ingredients are generally present in a concentration from 5 to 98 weight percent, preferably 10 to 90 weight percent. Such compositions are typically diluted with an inert carrier, such as water, before making a postemergence, foliar application to exposed weed and crop foliage. The diluted compositions usually applied as a postemergence, foliar application to weeds or the locus of weeds generally contain 0.03 to 20 weight percent active ingredient and preferably contain 0.1 to 10 weight percent.

The present compositions can be applied to weeds or their locus by the use of conventional ground or aerial dusters, sprayers, and granule applicators, by addition to irrigation or paddy water, and by other conventional means known to those skilled in the art.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLES

Evaluation of Postemergence Herbicidal Activity of Mixtures under Field Conditions Methodology

Trial sites were located in various countries around the world, including Brazil, United States, Hungary, Indonesia and Malaysia, in non-crop and perennial tree crop plantations. Trials were conducted using normal small plot R&D trials using standard research methodology. Trial plots were between 2 to 4 meters (m) wide by 3 to 10 m long. All treatments were applied using a randomized complete block or factorial trial design with 3-4 replications per treatment. The trial sites had naturally occurring populations of weeds. The weed spectrum included, but was not limited to, scarlet pimpernel (Anagallis arvensis L., ANGAR), tropical carpetgrass (Axonopus compressus, AXOCO), Canada thistle (Cirsium arvense (L.) Scop., CIRAR), calopo (Calopogonium mucunoides, CLOMU), Bengal dayflower (Commelina benghalensis L., COMBE), field bindweed (Convolvus arvensis, CONAR), horseweed (Conyza canadensis (L.) Cronq., ERICA), kochia (Kochia scoparia (L.) Schrad., KCHSC), common mallow (Malva neglecta Wallr., MALNE), African mile-a-minute (Mikania cordata (Burm. f.) B. L., MIKCO), slender panicgrass (Ottochloa nodosa, OTTNO), paspalum (Paspalum conjugatum Bergius, PASCO), wild buckwheat (Polygonum convolvulus L., POLCO) and stinging nettle (Urtica dioica L., URTDI).

Treatments consisted of tank mixes of commercially available formulations of fluoroxypyr-meptyl ester (Starane® 200, Starane® 250, Starane® Ultra) and glyphosate (Roundup® isopropylammonium salt, Glizmax, Gliz) applied in water. The application volume varied from location to location but was from 100 to 450 liters per hectare (L/ha). Application was made using a precision gas backpack sprayer at pressures ranging from 150 to 300 kPA pressure using 2 to 4 m booms utilizing 4 to 8 flat fan nozzles to broadcast the treatments to the weeds and to the soil.

The treated and control plots were rated blind at various intervals after application. Ratings were based on Percent (%) Visual weed control, where 0 corresponds to no control and 100 corresponds to complete control. Results are reported in Tables 1 to 4.

Evaluation

Data were collected and analyzed using various statistical methods.

Colby's equation was used to determine the herbicidal effects expected from the mixtures (Colby, S. R. Calculation of the synergistic and antagonistic response of herbicide combinations. Weeds 1967 15, 20-22).

The following equation was used to calculate the expected activity of mixtures containing two active ingredients, A and B:

Expected=A+B−(A×B/100)

A=observed efficacy of active ingredient A at the same concentration as used in the mixture;

B=observed efficacy of active ingredient B at the same concentration as used in the mixture.

The results are summarized in Tables 1-4.

TABLE 1
Synergistic weed control of AXOCO, CLOMU, OTTNO and PASCO at
70 Days After Application (DAA) following a postemergence application
of Fluroxypyr-meptyl + Glyphosate-isopropylammonium to cereals

| | Glyphosate- | | | | | | | | |
|---|---|---|---|---|---|---|---|---|---|
| Fluroxypry- | isopropyl- | | | | | | | | |
| meptyl | ammonium | AXOCO | | CLOMU | | OTTNO | | PASCO | |
| (rate in gae/ha) | | Obs | Exp* | Obs | Exp* | Obs | Exp* | Obs | Exp* |
| 53 | 0 | 0 | — | 69 | — | 0 | — | 0 | — |
| 0 | 500 | 59 | — | 64 | — | 59 | — | 59 | — |
| 53 | 500 | 89 | 59 | 99 | 88 | 84 | 59 | 89 | 59 |

TABLE 2
Synergistic weed control of MIKCO, KCHSC and ERICA at 28 to 43
Days After Application (DAA) following a postemergence application
of Fluroxypyr-meptyl + Glyphosate-isopropylammonium to cereals

| | Glyphos- | | | | | | | | | |
|---|---|---|---|---|---|---|---|---|---|---|
| | ate- | | | | | | | | | |
| Fluroxy- | isopropyl | Days | | | | | | | | |
| pyr- | ammon- | After | | | | | | | | |
| meptyl | ium | Appli- | MIKCO | | KCHSC | | ERICA | | URTDI | |
| (rate in grams ae/ha) | | cation | Obs | Exp* | Obs | Exp* | Obs | Exp* | Obs | Exp* |
| 50 | 0 | 28 | 42 | — | — | — | — | — | — | — |
| 0 | 360 | 28 | 58 | — | — | — | — | — | — | — |
| 50 | 360 | 28 | 94 | 79 | — | — | — | — | — | — |
| 67 | 0 | 36 | — | — | 48 | — | — | — | — | — |
| 0 | 280 | 36 | — | — | 23 | — | — | — | — | — |
| 67 | 280 | 36 | — | — | 73 | 59 | — | — | — | — |
| 140 | 0 | 43 | — | — | — | — | 4 | — | — | — |
| 0 | 560 | 43 | — | — | — | — | 18 | — | — | — |
| 140 | 560 | 43 | — | — | — | — | 86 | 21 | — | — |
| 140 | 0 | 43 | — | — | — | — | 4 | — | — | — |
| 0 | 840 | 43 | — | — | — | — | 73 | — | — | — |
| 140 | 840 | 43 | — | — | — | — | 98 | 73 | — | — |
| 200 | 0 | 28 | — | — | — | — | — | — | 10 | — |
| 0 | 1100 | 28 | — | — | — | — | — | — | 24 | — |
| 200 | 1100 | 28 | — | — | — | — | — | — | 95 | 31 |

TABLE 3
Synergistic weed control of COMBE, POLCO and CONAR 14 to 59 Days
After Application (DAA) following a postemergence application of
Fluroxypyr-meptyl + Glyphosate-isopropylammonium to cereals

| | Glypho- | | | | | | | | | |
|---|---|---|---|---|---|---|---|---|---|---|
| | sate- | | | | | | | | | |
| Fluroxy- | isopropyl- | Days | | | | | | | | |
| pyr- | ammon- | After | | | | | | | | |
| meptyl | ium | Appli- | COMBE | | POLCO | | CONAR | | MALNE | |
| (rate in grams ae/ha) | | cation | Obs | Exp* | Obs | Exp* | Obs | Exp* | Obs | Exp* |
| 200 | 0 | 28 | 36 | — | — | — | — | — | — | — |
| 0 | 710 | 28 | 43 | — | — | — | — | — | — | — |
| 200 | 710 | 28 | 84 | 63 | — | — | — | — | — | — |
| 200 | 0 | 14 | — | — | 52 | — | — | — | 48 | — |
| 0 | 1000 | 14 | — | — | 25 | — | — | — | 14 | — |
| 200 | 1000 | 14 | — | — | 80 | 64 | — | — | 90 | 55 |
| 200 | 0 | 59 | — | — | — | — | 47 | — | — | — |
| 0 | 2000 | 59 | — | — | — | — | 55 | — | — | — |
| 200 | 2000 | 59 | — | — | — | — | 91 | 76 | — | — |
| 400 | 0 | 14 | — | — | 68 | — | — | — | — | — |
| 0 | 1500 | 14 | — | — | 60 | — | — | — | — | — |
| 400 | 1500 | 14 | — | — | 98 | 87 | — | — | — | — |

TABLE 4
Synergistic weed control of CIRAR, CONAR, POLCO and ANGAR at 14
to 59 Days After Application (DAA) following a postemergence appliaction
of Fluroxypyr-meptyl + Glyphosate-isopropylammonium to cereals

| | Glyphosate- | Days | | | | | | | | |
|---|---|---|---|---|---|---|---|---|---|---|
| Fluroxypyr- | isopropyl- | After | | | | | | | | |
| meptyl | ammonium | Appli- | CIRAR | | CONAR | | POLCO | | ANGAR | |
| (rate in grams ae/ha) | | cation | Obs | Exp* | Obs | Exp* | Obs | Exp* | Obs | Exp* |
| 300 | 0 | 59 | 3 | — | — | — | — | — | — | — |
| 0 | 1000 | 59 | 58 | — | — | — | — | — | — | — |
| 300 | 1000 | 59 | 72 | 60 | — | — | — | | — | — |
| 300 | 0 | 59 | — | — | 50 | — | — | — | — | — |
| 0 | 1500 | 59 | — | — | 43 | — | — | — | — | — |
| 300 | 1500 | 59 | | — | 91 | 72 | — | | — | — |
| 300 | 0 | 59 | — | — | 50 | — | — | — | — | — |
| 0 | 2000 | 59 | | — | 55 | — | — | — | — | — |
| 300 | 2000 | 59 | — | — | 94 | 77 | — | — | — | — |
| 400 | 0 | 14 | 7 | — | — | — | 60 | — | 0 | — |
| 0 | 1000 | 14 | 58 | — | — | — | 25 | — | 43 | — |
| 400 | 1000 | 14 | 73 | 61 | — | — | 87 | 70 | 63 | 43 |
| 400 | 0 | 59 | — | — | 48 | — | — | | — | — |
| 0 | 2000 | 59 | — | — | 55 | — | — | — | — | — |
| 400 | 2000 | 59 | — | — | 96 | 77 | — | — | — | — |

ANGAR = Anagallis arvensis L., scarlet pimpernel
AXOCO = Axonopus compressus, tropical carpetgrass
CIRAR = Cirsium arvense (L.) Scop., Canada thistle
CLOMU = Calopogonium mucunoides, calopo
COMBE = Commelina benghalensis L., Bengal dayflower
CONAR = Convolvus arvensis, field bindweed
ERICA = Conyza canadensis (L.) Cronq., horseweed
KCHSC = Kochia scoparia (L.) Schrad., kochia
MALNE = Malva neglecta Wallr., common mallow
MIKCO = Mikania cordata (Burm. f.) B.L. Robins., African mile-a-minute
OTTNO = Ottochloa nodosa, slender panicgrass
PASCO = Paspalum conjugatum Bergius, sour paspalum
POLCO = Polygonum convolvulus L., wild buckwheat
URTDI = Urtica dioica L., stinging nettle
Obs = Observed weed control
Exp* = Expected weed control, as per Cobly's equation calculation

What is claimed is:

1. A herbicidal composition comprising a herbicidally effective amount of (a) fluoroxypyr or salt or ester thereof and (b) glyphosate or salt or ester thereof.

2. The composition of claim 1, wherein (a) is fluoroxypyr meptyl and (b) is glyphosate ammonium.

3. The composition of claim 1, wherein the carboxylic acid equivalent weight ratio of fluoroxypyr or salt or ester thereof to glyphosate or salt or ester thereof is from 2:1 to 1:40.

4. The composition of claim 3, wherein the carboxylic acid equivalent weight ratio is from 1:1 to 1:20.

5. The composition of claim 4, wherein the carboxylic acid equivalent weight ratio is from 1:2.5 to 1:10.

6. The composition of claim 2, wherein the carboxylic acid equivalent weight ratio of fluoroxypyr meptyl to glyphosate ammonium is from 2:1 to 1:40.

7. The composition of claim 2, wherein the carboxylic acid equivalent weight ratio of fluoroxypyr meptyl to glyphosate ammonium is from 1:1 to 1:20.

8. The composition of claim 2, wherein the carboxylic acid equivalent weight ratio of fluoroxypyr meptyl to glyphosate ammonium is from 1:2.5 to 1:10.

9. The composition of claim 1, further comprising a safener.

10. The composition of claim 1, further comprising one or more additional herbicides.

11. The composition of claim 1, wherein the composition further comprises an agriculturally acceptable adjuvant or carrier.

12. A method of treating undesirable vegetation comprising contacting the vegetation, locus of the vegetation, soil, or water a herbicidally effective amount of the composition of claim 1.

13. A method of treating undesirable vegetation comprising contacting the vegetation, locus of the vegetation, soil, or water a herbicidally effective amount of the composition of claim 8.

14. A method of treating undesirable vegetation comprising contacting the vegetation, locus of the vegetation, soil, or water a herbicidally effective amount of (a) fluoroxypyr or salt or ester thereof and (b) glyphosate or salt or ester thereof.

15. The method of claim 14, wherein (a) and (b) are applied post emergently.

16. The method of claim 14, wherein (a) and (b) are applied pre emergently.

17. The method of claim 14, wherein the undesirable vegetation is anagallis, axonopus, cirsium, calopogonium, commelina, convolvus, conyza, kochio, malva, mikania, ottochloa nodosa, pspalum polygonum, or urtica.

18. The method of claim 14, wherein the undesirable vegetation is ANGAR, AXOCO, CIRAR, CLOMU, COMBE, CONAR, ERICA, KCHSC, MALNE, MIKCO, OTTNO, PASCO, POLCO, or URTDI.

19. The method of claim 14, wherein the fluoroxypyr or salt or ester thereof is applied at a rate of from 50 gae/ha to 400 gae/ha and glyphosate or salt or ester thereof is applied at a rate of from 360 gae/ha to 2000 gae/ha.

20. The method of claim 14, wherein the undesirable vegetation is controlled in a cereal crop setting.
